(19) United States
(12) Patent Application Publication
(10) Pub. No.: US 2006/0076842 A1
(43) Pub. Date: Apr. 13, 2006

(54) Motor rotor

(75) Inventor: Jin Hyeong Park, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/245,098

(22) Filed: Oct. 7, 2005

(30) Foreign Application Priority Data
Oct. 8, 2004 (KR) 10-2004-0080247

(51) Int. Cl. H02K 9/00; H02K 9/06

(52) U.S. Cl. 310/62; 310/63; 310/67 R

(57) ABSTRACT

A motor rotor includes a rotator provided with a plurality of heat radiating holes for passing air therethrough, and a plurality of blades for moving air during a rotation of the rotator, each of the blades being detachable from the rotator. Further, each of the blades is bent and has a fixing portion for fixing each of the blades at the rotator and a free portion for guiding air into its corresponding heat radiating hole, the fixing portion and the free portion having a constant angle therebetween.

### FIELD OF THE INVENTION

The present invention relates to a motor rotor; and, more particularly, to blades of a rotor for an outer rotor type motor, the blades being detachable from a rotator.

### BACKGROUND OF THE INVENTION

In general, an induction electric motor driven by an induced electromotive force among various motor driving methods belongs to a rotating magnetic field type AC motor whose rotational force is generated by an interaction between a rotating magnetic field generated in a stator and an induced magnetic field generated in a rotor.

Such a motor can be variously designed as a single phase induction motor, a three phase induction motor, a three phase wound induction motor or the like. Further, since the motor is easily usable among the AC motor, it has been widely used in household electronics. Such an induction electric motor is suitable for a driving motor due to its characteristics in the constant number of rotations depending on a load and its long life span. Especially, among small-sized motors, a single phase condenser motor is most widely used.

The induction electric motor basically includes a housing; a stator fixed to the housing, for generating an induced magnetism with a power applied from an outside through a wound coil; and a rotor rotating together with a rotating shaft thereof by the induced magnetism generated from the stator, the rotating shaft being rotatably supported at a bearing installed at the housing.

The induction electric motor generates a rotational force by an interaction between a current induced in a secondary coil and a rotating magnetic field, the current being induced by an electromagnetic induction of a primary coil connected to a power supply. Depending on a relative position of the rotor and the stator, the induction electric motor is classified into an inner rotor type motor and an outer rotor type motor.

In the inner rotor type motor, since the rotor rotates inside the stator, a radius of the rotor is restricted. Accordingly, a torque generated in a same volume is relatively small and, further, a utility of an inner space deteriorates. For this reason, there has been suggested an outer rotor type induction motor in which the rotor is provided at an outside of the stator to increase a torque in the same volume and the inner space of the stator can be unitized for other purposes.

The outer rotor type induction motor is characterized in that a rotor having a driving shaft, a magnet, a rotor case and the like rotates outside a stator having an iron core, a core, a base, a bearing and the like. In other words, the rotor rotates along a periphery of the stator.

The aforementioned outer rotor type induction motor has been recently employed as a driving motor for a drum type washing machine. FIG. 5 shows a rotor of the conventional outer rotor type motor for the drum type washing machine.

In the conventional outer rotor type induction motor, the rotor is made by following steps: manufacturing an iron plate frame 510 through a press-processing or the like; positioning portions of a permanent magnet 540 at a back yoke 513 of the iron plate frame 510; and fixedly coupling the portions of the permanent magnet 540 to the back yoke 513 by a fixing resin.

Further, by fastening with bolts 532 (only one shown) a coupling member 530 to insertion openings 51b of a rotator 512 provided at a bottom surface of the iron plate frame 510, the coupling member 530 is coupled to the iron plate frame 510.

In addition, a plurality of cutaway blades 512a is formed at the rotator 512, wherein the blades 512a serve to discharge heat generated inside the iron plate frame 510 through heat radiating holes 512b by moving air during a rotation of the rotator 512.

However, the blades 512a are formed as a unit with the rotator 512 as shown in FIG. 6, so that it is difficult to form the blades 512a.

Specifically, in order to form the blades 512a at the rotator 512, first of all, the rotator 512 is cut in a character shape to form cutaway portions so that the cutaway portions are radially formed to be centered on a center of the rotator 512. Next, the cutaway portions are bent toward an upper portion of the rotator 512, thereby forming the blades 512a and the heat radiating holes 512b at spaces where the cutaway portions used to exist as shown in FIG. 6.

In such a blade formation, however, a process for forming the [-shaped cutaway portions at the rotator is required beforehand. Further, it is difficult to bend the respective blades while maintaining a constant inclined angle thereof.

### SUMMARY OF THE INVENTION

It is, therefore, an object of the present invention to provide a motor rotor capable of easily and quickly providing blades for moving air during a rotation of a rotator at a rotator.

In accordance with the present invention, there is provided a motor rotor including a rotator provided with a plurality of heat radiating holes for passing air therethrough, and a plurality of blades for moving air during a rotation of the rotator, each of the blades being detachable from the rotator.

### BRIEF DESCRIPTION OF THE DRAWINGS

The above and other objects and features of the present invention will become apparent from the following description of preferred embodiments, given in conjunction with the accompanying drawings, in which:

FIG. 1A shows an exploded perspective view of a rotor in accordance with a first preferred embodiment of the present invention;

FIG. 1B is an expanded view of “a” part of FIG. 1A;

FIG. 2 describes a partially enlarged sectional view illustrating an installation state of blades shown in FIG. 1A;

FIG. 3 provides a partially enlarged sectional view illustrating an installation state of a rotator blade in accordance with a second preferred embodiment of the present invention;

FIG. 4 represents a partially enlarged sectional view illustrating an installation state of a rotator blade in accordance with a third preferred embodiment of the present invention;

FIG. 5 offers an exploded perspective view of the conventional rotor; and

FIG. 6 presents a partially enlarged sectional view of a rotator blade of FIG. 5.

### DETAILED DESCRIPTION OF THE PREFERRED EMBODIMENTS

Hereinafter, preferred embodiments of the present invention will be described in detail with reference to the accompanying drawings.

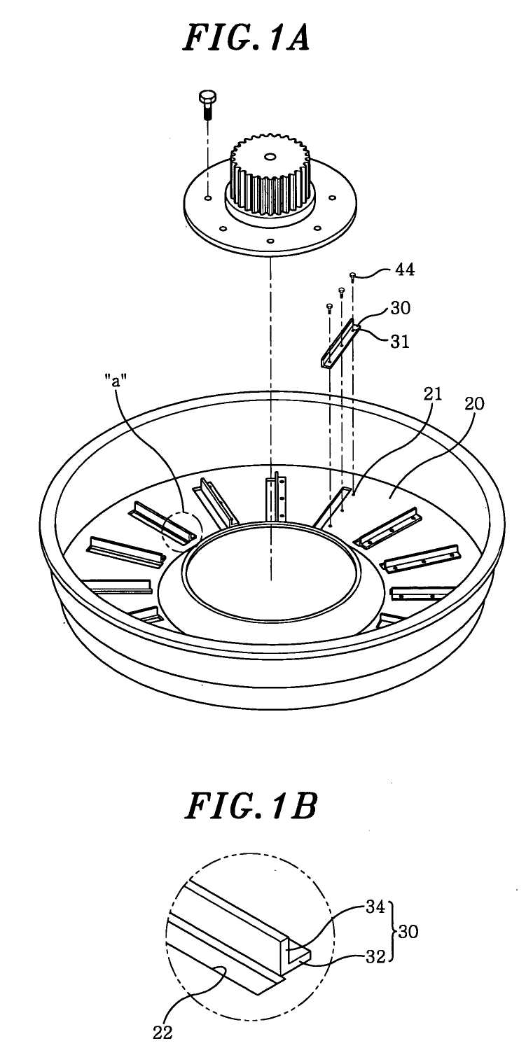

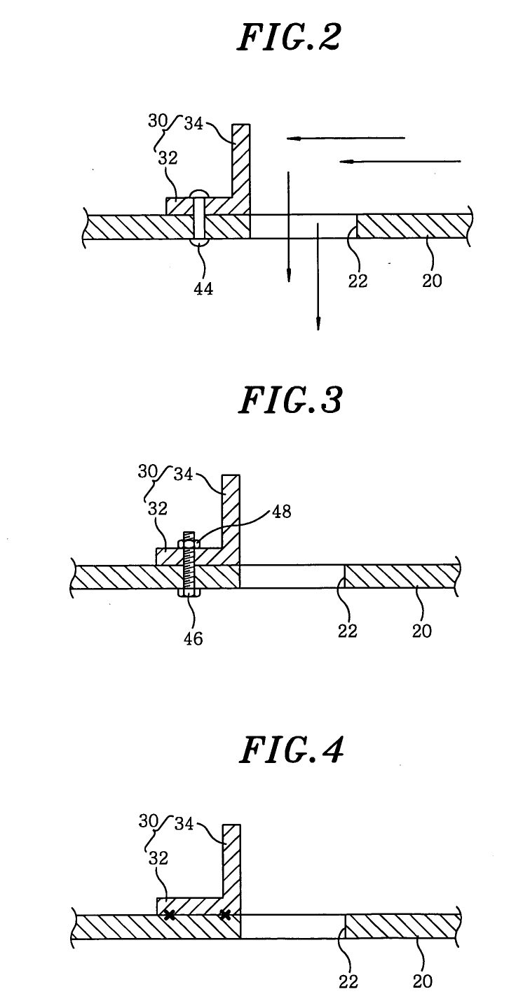

FIG. 1A shows an exploded perspective view of a rotor in accordance with a first preferred embodiment of the present invention; FIG. 1B is an expanded view of “a” part of FIG. 1A; and FIG. 2 describes a partially enlarged sectional view illustrating an installation state of blades shown in FIG. 1A.

Since the outer rotor type motor in accordance with preferred embodiments of the present invention is identical to the conventional one, excepting a rotor and therefore the rotor will now be described in detail.

As illustrated in FIGS. 1A, 1B and 2, a rotor in accordance with the first preferred embodiment includes a rotator 20 provided with approximately rectangular heat radiating holes 22 and blades 30 each of which has a fixing portion 32 and a free portion 34. The rotator 20 and the fixing portion 32 of the blade 30 are respectively provided with a plurality of, e.g., three through-holes 21 and a plurality of, e.g., three insertion holes 31 corresponding the through-holes 21. The rectangular heat radiating holes 22 are radially bored in the rotator 20 to be centered on a center of the rotator 20.

Each of the fixing portions 32 is contacted with the rotator 20 and each of the free portions 34 is bent from the fixing portion 32 so that a constant angle is formed between the fixing portion 32 and the free portion 34. For example, the constant angle ranges from about 45° to about 90°.

Accordingly, if the fixing portion 32 is adhered to a top surface of the rotator 20, the free portion 34 maintains an angle ranging from about 45° to 90° with respect to the top surface of the rotator 20.

Due to an installation angle of the free portions 34, air can be easily led to the heat radiating holes 22 during a rotation of the rotator 20.

Hereinafter, an installation of the blade and an operation thereof will be described.

The blade 30 is bent so that the fixing portion 32 and the free portion 34 can maintain a constant angle therebetween.

Next, the fixing portion 32 of the blade 30 is positioned on the top surface of the rotator 20 so that the boundary line between the fixing portion 32 and the free portion 34 is aligned with one longitudinal side of the heat radiating hole 22.

Thereafter, the fixing portion 32 of the blade 30 is fastened to the rotator 20 by fitting, e.g., rivets 44 as a fastening member into the insertion holes 31 and the through-holes 21.

When the rotator 20 rotates, the free portions 34 of the blades 30 guide air to their corresponding heat radiating holes 22. Specifically, air collided with the free portions 34 of the blades 30 is discharged to the outside through the heat radiating holes 22 (see FIG. 3).

The blades 30 are installed at the rotator 20 only by inserting the rivets 44 into the insertion holes 31 of the fixing portions 32 and the through-holes 21 of the rotator 20, so that it is possible to quickly and easily provide the blades 30 at the rotator 20.

FIG. 3 illustrates a blade installation in accordance with a second preferred embodiment of the present invention.

As shown in FIG. 3, the second embodiment is identical to those of the first one except in that a fastening member for fastening the fixing portion 32 of the blade 30 to the rotator 20 has one or more bolts 46 and a same number of nuts 48 as that of the bolts 46.

In the second embodiment, the blade 30 is installed at the rotator 20 by fastening the fixing portion 32 to the rotator 20 by means of the bolts 46 and the nuts 48. Since the fixing portion 32 is fixed to the rotator 20 by the bolts 46 and the nuts 48, the fixing portions 32 can be firmly fixed to the rotator 20 and also the blade 30 can be easily exchanged.

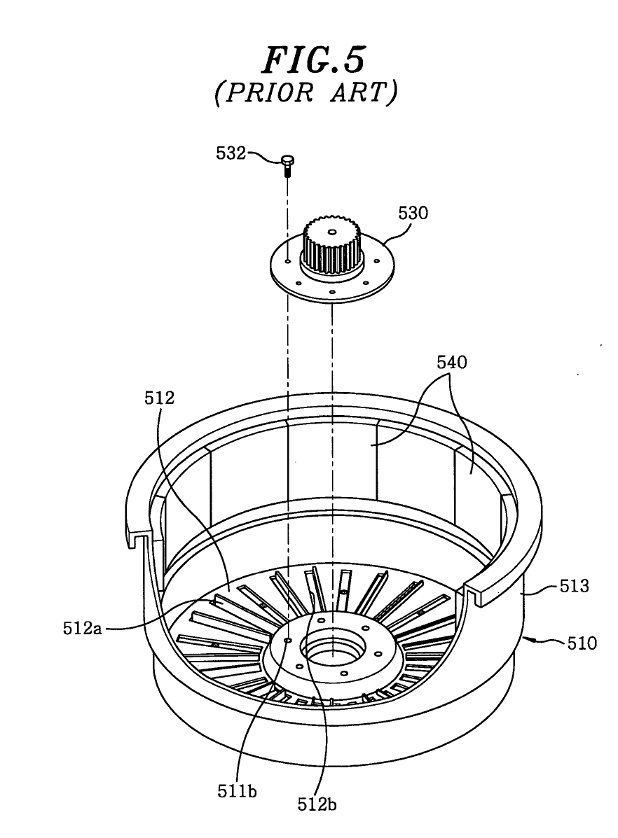

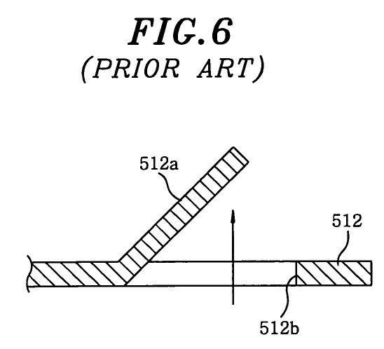

FIG. 4 illustrates a blade installation in accordance with a third preferred embodiment of the present invention.

As shown in FIG. 4, the third embodiment is identical to those of the first one except in that a fastening method for fastening the fixing portion 32 of the blade 30 to the rotator 20 is a spot welding.

After the fixing portion 32 of the blade 30 is positioned on the top surface of the rotator 20 so that the boundary line between the fixing portion 32 and the free portion 34 is aligned with one longitudinal side of the heat radiating hole 22, the fixing portion 32 is fixed to the rotator 20 by the spot welding.

Since the fixing portion 32 is fixed to the rotator 20 by the spot welding, the blade 30 can be quickly and easily installed at the rotator 20.

In the present invention, the blade that is so bent as to have the fixing portion and the free portion can be installed the rotator by various fastening members or fastening methods. Therefore, the blade can be quickly and easily provided at the rotator and further can be exchanged piece by piece.

While the invention has been shown and described with respect to the preferred embodiments, it will be understood by those skilled in the art that various changes and modification may be made without departing from the scope of the invention as defined in the following claims.

What is claimed is:

1. a motor rotor comprising:
a rotator provided with a plurality of heat radiating holes for passing air therethrough; and
a plurality of blades for moving air during a rotation of the rotator, each of the blades being detachable from the rotator.

2. The motor rotor of claim 1, wherein each of the blades is bent and has a fixing portion for fixing each of the blades at the rotator and a free portion for guiding air into its corresponding heat radiating hole, the fixing portion and the free portion having a constant angle therebetween.

3. The motor rotor of claim 2, wherein each of the blades is installed at the rotator so that the boundary line between its fixing portion and its free portion is aligned with one longitudinal side of the heat radiating hole.

4. The motor rotor of claim 1, wherein the blades are respectively installed at the rotator by one or more rivets.

5. The motor rotor of claim 1, wherein the blades are respectively installed at the rotator by one or more bolts and one or more nuts.

6. The motor rotor of claim 1, wherein the blades are respectively installed at the rotator by a spot welding.

7. The motor rotor of claim 1, wherein the heat radiating holes are rectangular and are radially formed at the rotator to be centered on a center of the rotator.
